(19) United States
(12) Patent Application Publication
(10) Pub. No.: US 2026/0037221 A1
(43) Pub. Date: Feb. 5, 2026

(54) COMPUTER STORAGE DEVICE AND CLASSIFICATION METHOD THEREOF

(71) Applicant: MACRONIX INTERNATIONAL CO., LTD., Hsinchu (TW)

(72) Inventors: Ming-Liang WEI, Kaohsiung City (TW); Hsiang-Pang LI, Zhubei City (TW); Yuan-Hao ZHONG, Hsinchu County (TW); Chia-Lin YANG, Taipei City (TW)

(21) Appl. No.: 19/062,121

(22) Filed: Feb. 25, 2025

Related U.S. Application Data
(60) Provisional application No. 63/678,549, filed on Aug. 2, 2024.

(51) Int. Cl. G06F 7/544; G06F 3/06

(52) U.S. Cl. CPC G06F 7/5443; G06F 3/0604; G06F 3/0658; G06F 3/0679

(57) ABSTRACT

A first operation is performed on input data and first weights to generate first computation results. The first computation results are compared with a threshold value to obtain a comparison result. Based on the comparison result, a first portion of second weights corresponding to candidate classes are read out from the storage unit. A bit length of the second weight is larger than a bit length of the first weight. A second operation is performed on the input data and the first portion of the second weights to generate second computation results. Based on the second computation results, a plurality of target candidate classes with top one or several highest product values are selected from the candidate classes.

This application claims the benefit of U.S. provisional patent application Ser. No. 63/678,549, filed Aug. 2, 2024, the disclosure of which is incorporated by reference herein in its entirety.

### TECHNICAL FIELD

The present invention relates to a computer storage device and a classification method thereof.

### BACKGROUND

Extreme classification is an emerging field in machine learning that deals with a large number of categories. This field has gained prominence due to the widespread use of multi-class and multi-label classification tasks. The labels in these tasks are diverse, detailed, and complex, leading to a significant increase in the number of categories compared to traditional classification tasks. This complexity is particularly prevalent in modern real-world applications such as product search, recommendation systems, language models, and image recognition, which heavily rely on extreme classification to identify the most relevant categories or labels from a vast number of categories. The number of categories or labels in extreme classification is continuously increasing, reaching even millions or billions.

Generally, a neural network performing extreme classification will at least include an encoding layer and a final fully-connected layer. The final fully-connected layer can also be referred to as the final classification layer.

The final classification layer is facing increasing challenges in real-world scenarios and next-generation applications. It has become the performance bottleneck of the overall model, consuming a large amount of resources. This is because the computational complexity and memory usage are proportional to the scale of the categories, a trend that is growing and expected to continue. As a result, the final classification layer is becoming a critical performance bottleneck, and it is therefore preferable to accelerate the operation of the final classification layer. The expansion of categories has made data transfer a significant issue, far exceeding the capacity of chip memory, and the parameters involved in these transfers lack reusability. Adopting a memory-centric approach is crucial to addressing this challenge. Current technology employs a near-data processing technique, handling the final layer close to DRAM, thereby eliminating extensive data transfers across the system bus. However, due to the limited bit density of main memory, this solution finds it difficult to store the final layer, as the parameters of the classifier could reach thousands of gigabytes.

### SUMMARY

According to one embodiment, a classification method for a computer storage device is provided. The classification method comprises: performing a first operation on input data and a plurality of first weights stored in a computing in-memory (CIM) unit of the storage device to generate a plurality of first computation results; comparing the first computation results with a threshold value to obtain a comparison result; based on the comparison result, reading out a first portion of a plurality of second weights corresponding to a plurality of candidate classes from a storage unit of the storage device, wherein the plurality of the second weights are stored in the storage unit and corresponding to the plurality of the first weights, and a bit length of the second weight is larger than a bit length of the first weight; performing a second operation on the input data and the first portion of the plurality of the second weights to generate a plurality of second computation results; and based on the second computation results, selecting a plurality of target candidate classes with top one or several highest product values from the candidate classes.

According to another embodiment, a storage device is provided. The computer storage device comprises: a computing in-memory unit storing a plurality of first weights; a storage unit storing a plurality of second weights, the plurality of second weights are corresponding to the plurality of first weights, wherein a bit length of the second weight is larger than a bit length of the first weight; a controller coupled to the computing in-memory unit and the storage unit; and a classification accelerator coupled to the computing in-memory unit, the storage unit and the controller. The computing in-memory unit calculates a plurality of first computation results of the plurality of first weights with an input data. The classification accelerator compares the first computation results with a threshold value to obtain a comparison result. Based on the comparison result, the controller reads out a first portion of the plurality of second weights corresponding to a plurality of candidate classes from the storage unit. The classification accelerator calculates a plurality of second computation results of the first portion of the plurality of second weights with the input data. Based on the second computation results, the classification accelerator selects a plurality of target candidate classes with top one or several highest product values from the candidate classes.

### BRIEF DESCRIPTION OF THE DRAWINGS

FIG. 1 illustrates a functional block diagram of a Solid-State Drive (SSD) according to an embodiment of the application.

FIG. 2 shows a flowchart of the extreme classification method according to an embodiment of the application.

FIG. 3 illustrates the concept of how the threshold affects top-K.

FIG. 4 illustrates the concept of threshold optimization according to an embodiment of the application.

FIG. 5 shows a schematic diagram of the threshold adjuster according to an embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

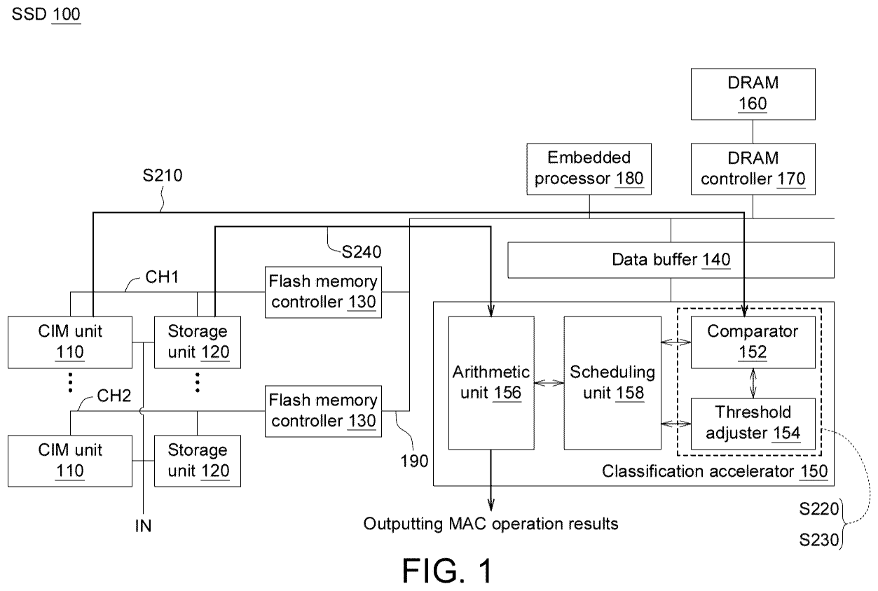

FIG. 1 illustrates a functional block diagram of a Solid-State Drive (SSD) according to an embodiment of the application. The SSD is used as an example to explain the computer storage device in this embodiment, but it should be understood that this application is not limited to this, and other types of storage devices can also be applied.

The SSD 100 according to an embodiment of this application includes: at least one computing-in-memory (CIM) unit 110, at least one storage unit 120, at least one flash memory controller 130, a data buffer 140, a classification accelerator 150, a dynamic random-access memory (DRAM) 160, a DRAM controller 170, an embedded processor 180, and a bus 190. Here, the CIM unit 110 and storage unit 120 are explained using three-dimensional NAND flash memory as an example, but it should be understood that the application is not limited to this. The classification accelerator 150 includes: a comparator 152, a threshold adjuster 154, an arithmetic unit 156, and a scheduling unit 158. The scheduling unit 158 can be implemented using a state machine.

The CIM unit 110 is coupled to the bus 190. The CIM unit 110 includes multiple CIM cells (not shown). The CIM unit 110 stores multiple approximate model weights. These approximate model weights are, for example, full-dimensional weights but with fewer bits (e.g., but not limited to, 4 bits).

The storage unit 120 is coupled to the bus 190. The storage unit 120 includes multiple storage cells (not shown). The storage unit 120 stores multiple full-dimension floating weights (e.g., 32 bits). For the CIM unit 110 and storage unit 120 coupled to the same channel (CH1 or CH2), the approximate model weights in the CIM unit 110 correspond one-to-one with the full-dimension floating weights in the storage unit 120. That is, the full-dimension floating weights in the relevant storage unit 120 are projected into the same dimension but as lower-precision approximate model weight matrices to be stored in the CIM unit 110. In other words, the approximate model weights in the CIM unit 110 are full-dimension weights with lower precision, while the full-dimension floating weights in the storage unit 120 are full-dimension weights with higher precision. The bit number of the approximate model weights in the CIM unit 110 is less than that of the full-dimension floating weights in the storage unit 120. In one embodiment of the application, the weights stored in the storage unit 120 and the CIM unit 110 have different precisions, but the same or different dimensions, which are still within the spirit and scope of the application.

The flash memory controller 130 is coupled to the bus 190 and is used to control the CIM unit 110 and storage unit 120.

The data buffer 140 is coupled to the bus 190 and is used to buffer data output by the CIM unit 110, the storage unit 120, or the classification accelerator 150.

The classification accelerator 150 is used to perform extreme classification. The details of the classification accelerator 150 will be explained below.

The DRAM 160 is used for storing data.

The DRAM controller 170 is coupled to the DRAM 160 and the bus 190 for controlling the DRAM 160.

The embedded processor 180 is coupled to the bus 190.

The comparator 152, the threshold adjuster 154, the arithmetic unit 156, and the scheduling unit 158 are coupled to each other.

The comparator 152 compares the calculation results of the computing-in-memory (CIM) unit 110 with a threshold value to identify which vectors exceed the threshold.

The threshold adjuster 154 adjusts the threshold value for the comparator 152.

The arithmetic unit 156 performs calculations on the full-dimension floating weights stored in the storage unit 120 and the input data IN. For example, but not limited to, the arithmetic unit 156 may perform a floating-point 32 (FP32) multiply-accumulate operation (MAC). When the classification accelerator is used for image classification, the input data IN may be image data. Of course, the application is not limited to this.

The scheduling unit 158 arranges the operations of the comparator 152, the threshold adjuster 154, the arithmetic unit 156, and others.

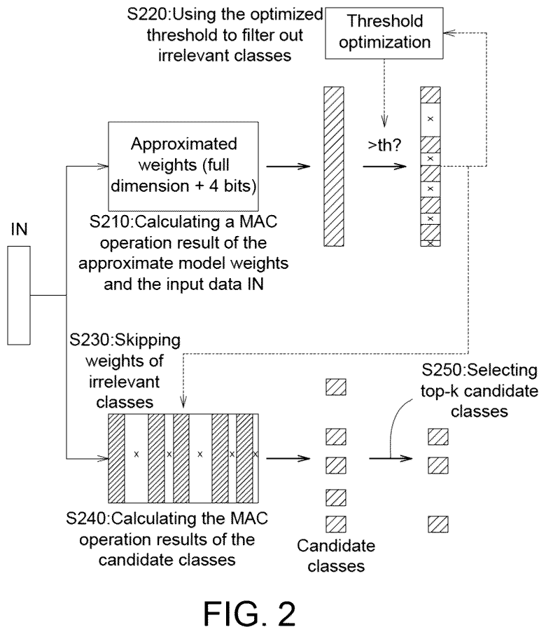

FIG. 2 shows a flowchart of the extreme classification method according to an embodiment of the application. Please refer to FIG. 2 in conjunction with FIG. 1.

In step S210, the input data IN is input to the CIM unit 110 to calculate a MAC (Multiply Accumulate) operation result of the approximate model weights and the input data IN. The main advantage of step S210 is that it eliminates the need to move weights to the arithmetic unit, allowing MAC operations to be performed simultaneously and directly within multiple NAND flash memory packages.

In step S220, the CIM unit 110 sends the MAC operation results of the approximate model weights and the input data IN to the comparator 152. The comparator 152 compares these MAC operation results with the threshold value to filter out MAC operation results below the threshold. In other words, in step S220, the comparator uses the threshold to filter out irrelevant classes. If a first MAC operation result of a first approximate model weight is below the threshold, the first full-dimension floating weight corresponding to the first approximate model weight is defined as an irrelevant class. Conversely, if a second MAC operation result of a second approximate model weight is above the threshold, the second full-dimension floating weight corresponding to the second approximate model weight is defined as a candidate class.

In step S230, the comparator 152 returns the comparison results to the flash memory controller 130 so that the flash memory controller 130 can omit the weights of irrelevant classes. That is, based on the comparison results, the flash memory controller 130 decides to read out the full-dimension floating weights of the candidate classes from the storage unit 120 and send them to the arithmetic unit 156 of the classification accelerator 150, while also deciding not to read out the full-dimension floating weights of the “irrelevant classes” from the storage unit 120.

In step S240, the MAC operation results for the candidate classes are calculated by the arithmetic unit 156.

In step S250, based on the MAC operation results of the candidate classes by the arithmetic unit 156, the top K classes which have the top K highest MAC product values are selected as the final classes, for example but not limited by, the embedded processor 180.

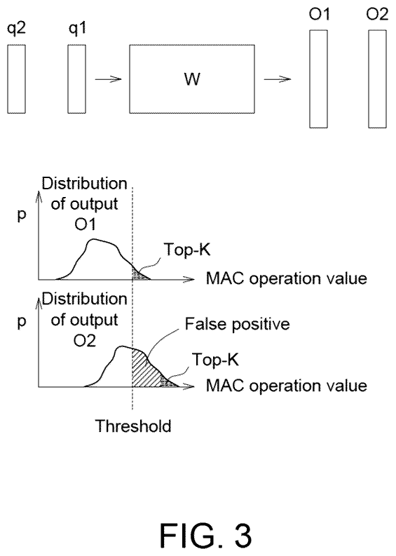

FIG. 3 illustrates the concept of how the threshold affects top-K. As shown in FIG. 3, when inputs q1 and q2 are fed into the weight matrix W, two outputs, o1 and o2, can be obtained. FIG. 3 further shows the distribution of outputs o1 and o2. The MAC product values above the threshold can be considered relevant to the top-K (in FIG. 3, top-K refers to the top K highest MAC product values).

If the threshold is low, the top-K of a small-mean distribution can be preserved. For example, the distribution of output o1 represents a small-mean distribution. In one embodiment of the application, for large-mean distribution, the same threshold as used in small-mean distribution will make more candidate classes be selected and leading to a higher likelihood of false positives. The distribution of output o2 represents a large-mean distribution.

Therefore, in one embodiment of the application, by adjusting the threshold (i.e., optimizing the threshold), the issue of false positives in large-mean distributions can be avoided.

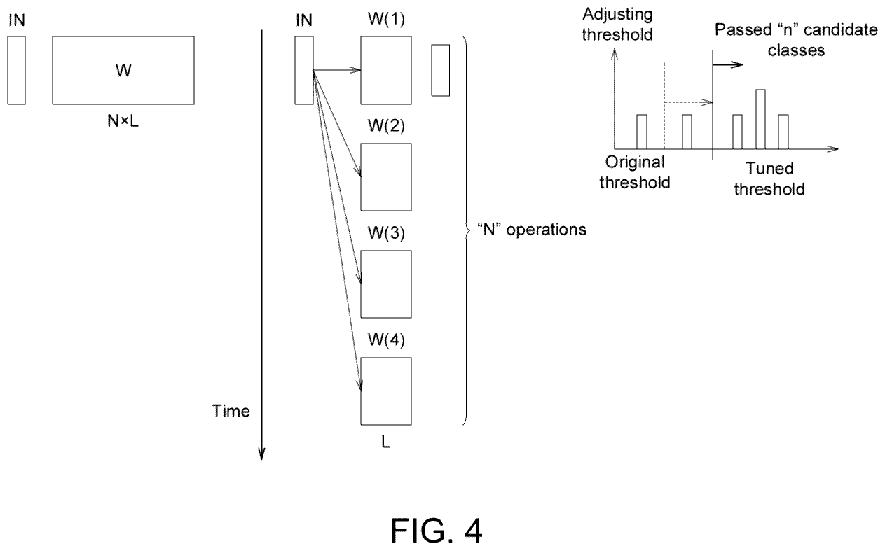

FIG. 4 illustrates the concept of threshold optimization according to an embodiment of the application. In this embodiment, when adjusting the threshold, since it is not possible to compute all the weight matrices (i.e., the approximate model weights of the CIM unit 110) in one cycle, a single (approximate model) weight matrix (which is an N×L matrix) is divided into N (approximate model) sub-weights (each sub-weight W(1)−W(N) is a 1×L matrix). In this embodiment, the threshold used for the next iteration is adjusted based on the calculation results of the previous sub-weight (i.e., the threshold is adjusted iteratively). By iteratively adjusting the threshold, the number of passed classes (n) (i.e., the number of candidate classes per operation) multiplied by the number of operations (N) equals the target number k (k is the number of top-K candidate classes, also referred to as the “selected candidate class count”), i.e., N*n=k.

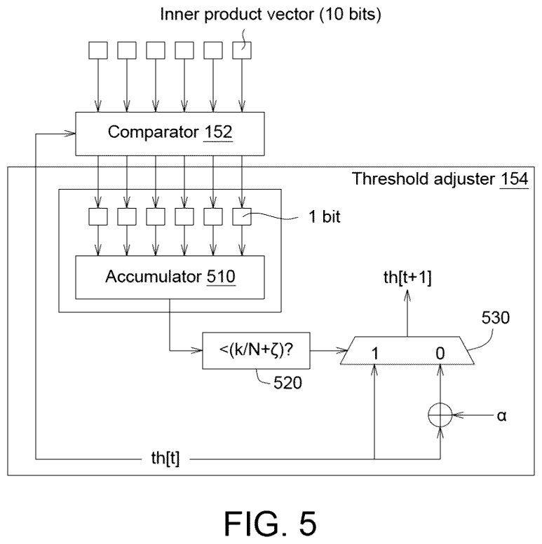

FIG. 5 shows a schematic diagram of the threshold adjuster 154 according to an embodiment of the application. The threshold adjuster 154 includes an accumulator 510, a threshold comparator 520, and a multiplexer 530. The threshold adjuster 154 can iteratively adjust the threshold to optimize it.

In FIG. 5, the comparator 152 compares the calculation results of the CIM unit 110 (which can be represented as an inner product vector, such as, but not limited to, a 10-bit value) with the threshold value th[t] and sends the comparison results to the accumulator 510 of the threshold adjuster 154. The accumulator 510 sends the accumulation results to the threshold comparator 520. Here, whenever the calculation results of the CIM unit 110 exceed the threshold value th[t], the accumulation result increases by 1.

The threshold comparator 520 compares the accumulation result (i.e., the number of candidate classes exceeding the threshold) with a reference value (k/N+ζ) to obtain a comparison result, and sends this comparison result to the multiplexer 530. The parameter “ζ” is used to prevent the updated threshold from becoming too high such that classes are over filtered.

When the comparison result of the threshold comparator 520 is less than the reference value (k/N+ζ), the threshold comparator 520 outputs a logical 1 to the multiplexer 530, so the updated threshold th[t+1]=th[t] (i.e., the threshold is not updated). Conversely, when the comparison result is equal to or greater than the reference value (k/N+ζ), the threshold comparator 520 outputs a logical 0 to the multiplexer 530, so the updated threshold th[t+1]=th[t]+α, where the parameter α is a threshold increment parameter, for example but not limited by, α=1˜1.5. In other words, when the comparison result is equal to or greater than the reference value (k/N+ζ), the threshold is incremented by the threshold increment parameter to obtain the updated threshold.

In one embodiment of the application, the classification accelerator 150 and its internal units can be implemented as control circuits or application-specific integrated circuits (ASIC). Alternatively, in other possible embodiments of the application, the classification accelerator 150 and its internal units could be implemented, for example, using a chip, a circuit block within a chip, a firmware code, or a circuit board containing several electronic components and wires.

Moreover, the application is not limited to the aforementioned methods of threshold updating; other methods or functions for updating the threshold may also be applied within the spirit and scope of the present application.

One embodiment of the application proposes a computing in-memory architecture using 3D-NAND flash memory to overcome the problems encountered in conventional extreme classification. This embodiment can eliminate the bottlenecks caused by internal data movement (in conventional technology, moving approximate model parameters from DRAM to the classification accelerator results in significant internal data movement) and provides a more accurate approximation algorithm to improve the filtering rate, thereby further reducing overall data transmission.

Additionally, this embodiment proposes a co-design approach of hardware and software to enhance the performance of extreme classification through data clustering and threshold optimization. Data clustering placement improves the efficiency of the computing in-memory architecture during execution. Threshold optimization ensures that the expected filtering rate is maintained throughout different inference processes. As a result, the classification accelerator in the present disclosure can improve the processing speed of extreme classification and reduce power consumption.

The present disclosure proposes an architecture capable of processing extreme classification tasks within a computer storage device (such as, but not limited to, an SSD). The present disclosure employs an approximate algorithm to simplify extreme classification tasks. The extreme classification process in the present disclosure consists of two stages: low-precision filtering and full-precision computation. Low-precision filtering refers to using CIM units to compute MAC operation results of the low-precision approximate model weights and the input, and preliminarily filtering out irrelevant classes using a comparator. Full-precision computation refers to computing the MAC operation results for the candidate classes that passed the low-precision filtering using high-precision weights (stored in storage unit 120) and selecting the high MAC product value classes from the candidate classes as the classification result.

In other words, during the low-precision (LP) filtering stage, the original full-precision matrix is projected into a low-precision matrix of the same dimension (stored in CIM unit 110). By computing the low-precision matrix and comparing the results with the threshold, it is determined which full-precision (FP) weight vectors need to be accurately calculated in the full-precision computation stage. After completing the full-precision computation stage, the final prediction results (top-K) can be obtained at the classification layer. These final prediction results are then returned to the host for subsequent model processing. This approach significantly reduces the transmission volume of full-precision vectors and the need to compute the entire full-precision matrix.

The present disclosure utilizes the computing in-memory (CIM) capability of 3D-NAND flash memory to execute approximate models to achieve a higher filtering rate, as the quantized weight matrix (also known as the approximate model) is stored in the CIM unit. In the application, the “filtering rate” refers to the proportion of weight vectors that are discarded while still being able to obtain the correct top-k weight vectors. Therefore, in the present disclosure, the low-precision weight matrix does not cause any internal data movement or SSD DRAM capacity issues, and the 3D-NAND flash memory can adapt well to data sets ranging from millions to billions of samples.

The present disclosure adopts an “approximate screening algorithm.” The main idea of this algorithm is to project the original full-precision weight matrix into a low-precision matrix, and compressing the full precision to 4 bits. By computing the low-precision matrix and comparing the results with the threshold, it is determined which full-precision weight vectors need to be calculated to obtain the final top-K prediction results in the classification layer. This method significantly reduces the need to compute the entire full-precision matrix, thereby alleviating the burden of full-precision computation.

The present disclosure can address the shortcomings of conventional technology, where channel bandwidth is not fully utilized. After the computing in-memory completes the multiply-accumulate (MAC) operation, the threshold can be used to determine whether it is a candidate class. The distribution of candidate classes represents the distribution of data access. However, if operated in the traditional way, the distribution of these candidate classes in each flash memory channel will be unbalanced, resulting in the transfer being limited by the flash memory channel with the most candidate classes. Ideally, all candidate classes would be evenly distributed across each flash memory channel to fully utilize the channel bandwidth. This unbalanced distribution could lead to a 30% to 50% overall performance drop. Therefore, in one embodiment of the application, before storing the approximate model weights into the CIM unit 110 and before storing the full-dimensional floating weights into the storage unit 120, weight preprocessing can be performed to improve channel balance. In the application, weight preprocessing involves storing weights that are likely to be read together evenly across different CIM units 110 and different storage units 120 in different channels. In this way, when reading the weights, multiple channels can be used simultaneously to transmit the weights, thereby improving the efficiency of weight reading and increasing channel balance.

Furthermore, the present disclosure can address the shortcomings of conventional technology where the threshold is not properly set. Since this embodiment uses a threshold to select candidate classes instead of using a sorting circuit to directly pick the top 1% of vectors as candidate classes, the threshold must be set very precisely to ensure that the top 1% of vectors is selected. However, in conventional technology, setting the threshold to a fixed value causes the number of candidate classes selected to vary in different inference processes, as the previous hidden layer vectors obtained in each inference process are different. There is no specific value that applies to every inference, leading to suboptimal filtering rates. If the filtering rate is not ideal, more data needs to be moved, resulting in overall performance degradation. Therefore, the present disclosure proposes an online threshold optimization adjustment method to avoid fluctuations in the filtering rate.

In summary, the present disclosure proposes a 3D-NAND flash memory architecture with computing in-memory to accelerate extreme classification. This computing in-memory architecture can avoid internal data movement, enabling the execution of approximate algorithms without incurring data transfer costs. By using an approximation algorithm designed for CIM 3D-NAND flash memory to improve the filtering rate, the present disclosure can further reduce overall data movement. Therefore, it can enhance the processing speed of extreme classification and reduce power consumption. This demonstrates the potential of the architecture in the present disclosure to handle the complexity of extreme classification in large-scale data sets.

The aforementioned solutions provided in the embodiments of this application have been primarily described in the context of extreme classification. It should be understood that to achieve the above functions, the classification accelerator includes the corresponding hardware structure and/or software modules that execute the functions. It will be readily apparent to persons skilled in the technical field that the units and algorithm steps described in this application can be implemented in hardware form or in a combination of hardware and computer software. Whether the functions are performed by hardware or by hardware driven by computer software depends on the specific application of the technical solution and design constraints. Persons skilled in the technical field may use different approaches to implement the functions described in each specific application, but such implementations should not be considered as exceeding the scope of this application.

In one embodiment of this application, the classification accelerator can be divided into functional modules based on the methods described above. For example, the division can be performed according to each corresponding function to obtain each functional module, or two or more functions can be integrated into a single processing module. The integrated module can be implemented in hardware form or as a software functional module. It should be noted that in the embodiments of this application, the division into modules is merely an example and represents a logical functional division. In the actual implementation process, other division methods may be used. The following description uses an example where each functional module is obtained by dividing according to each corresponding function.

Although the application may describe many specific details, these should not be construed as limiting the scope of the claimed invention, but rather as descriptions of the characteristics of specific embodiments. In this application, certain features described in the context of a single embodiment can also be implemented in combination within a single embodiment. Conversely, various features described in the context of a single embodiment can also be implemented individually or in any appropriate sub-combination in multiple embodiments. Additionally, although features may initially be described as functioning in certain combinations or may even be described as such combinations, in some cases, one or more features can be removed from the combination, and the described combination may target a sub-combination or a variation of a sub-combination. Similarly, although operations are depicted as being performed in a specific order in the illustrations, this should not be interpreted as requiring these operations to be performed in the specific order or sequence shown, or that all depicted operations must be performed to achieve the desired result.

While the aforementioned embodiments of the application only disclose some examples and implementations, changes, modifications, and enhancements to the described examples and implementations, as well as other implementations, can be made based on the disclosed content.

In conclusion, while the invention has been disclosed above with reference to certain embodiments, it is not intended to limit the invention. Those skilled in the art, without departing from the spirit and scope of the invention, may make various changes and modifications. Therefore, the scope of protection of the invention should be defined by the appended claims.

What is claimed is:

1. A classification method for a storage device, the classification method comprising:
performing a first operation on input data and a plurality of first weights stored in a computing in-memory (CIM) unit of the storage device to generate a plurality of first computation results;
comparing the first computation results with a threshold value to obtain a comparison result;
based on the comparison result, reading out a first portion of a plurality of second weights corresponding to a plurality of candidate classes from a storage unit of the storage device, wherein the plurality of the second weights are stored in the storage unit and corresponding to the plurality of the first weights, and a bit length of the second weight is larger than a bit length of the first weight;
performing a second operation on the input data and the first portion of the plurality of the second weights to generate a plurality of second computation results; and
based on the second computation results, selecting a plurality of target candidate classes with top one or several highest product values from the candidate classes.

2. The classification method for a storage device according to claim 1, wherein:
based on the comparison result, when reading out the first portion of the plurality of second weights corresponding to the plurality of candidate classes from the storage unit of the storage device, determining not to read out a second portion of the plurality of second weights corresponding to a plurality of irrelevant classes from the storage unit;
upon determining the first computation result of a specific first weight is lower than the threshold value, a class related to a specific second weight corresponding to the specific first weight is determined to be the irrelevant class; and
upon determining the first computation result of the specific first weight is higher than the threshold value, the class related to the specific second weight corresponding to the specific first weight is determined to be the candidate class.

3. The classification method for a storage device according to claim 1, further comprising:
dividing the first weights into a plurality of sub-weights; and
performing a third operation on the input data and the plurality of sub-weights to generate a plurality of third computation results, and adjusting the threshold value of a current sub-weight based on the third computation result of a previous sub-weight.

4. The classification method for a storage device according to claim 1, further comprising:
accumulating the comparison result to obtain an accumulation result;
comparing the accumulation result with a reference value to obtain an accumulation comparison result; and
updating the threshold value based on the accumulation comparison result and a threshold accumulation parameter.

5. The classification method for a storage device according to claim 4, wherein:
upon determining the first computation result of the computing in-memory unit is higher than the threshold value, the accumulation result is incremented by 1;
upon determining the accumulation comparison result is less than the reference value, the threshold value is not updated; and
upon determining the accumulation comparison result is equal to or greater than the reference value, the threshold value is incremented with the threshold accumulation parameter to obtain the updated threshold value.

6. A storage device comprising:
a computing in-memory unit storing a plurality of first weights;
a storage unit storing a plurality of second weights, the plurality of second weights are corresponding to the plurality of first weights, wherein a bit length of the second weight is larger than a bit length of the first weight;
a controller coupled to the computing in-memory unit and the storage unit; and
a classification accelerator coupled to the computing in-memory unit, the storage unit and the controller,
wherein
the computing in-memory unit calculates a plurality of first computation results of the plurality of first weights with an input data;
the classification accelerator compares the first computation results with a threshold value to obtain a comparison result;
based on the comparison result, the controller reads out a first portion of the plurality of second weights corresponding to a plurality of candidate classes from the storage unit;
the classification accelerator calculates a plurality of second computation results of the first portion of the plurality of second weights with the input data; and
based on the second computation results, the classification accelerator selects a plurality of target candidate classes with top one or several highest product values from the candidate classes.

7. The storage device according to claim 6, wherein:
based on the comparison result, when the controller reads out the first portion of the plurality of second weights corresponding to the plurality of candidate classes from the storage unit, the controller determines not to read out a second portion of the plurality of second weights corresponding to a plurality of irrelevant classes from the storage unit;
upon determining the first computation result of a specific first weight is lower than the threshold value, a class related to a specific second weight corresponding to the specific first weight is determined to be the irrelevant class; and
upon determining the first computation result of the specific first weight is higher than the threshold value, the class related to the specific second weight corresponding to the specific first weight is determined to be the candidate class.

8. The storage device according to claim 6, wherein the classification accelerator is configured for:
dividing the first weights into a plurality of sub-weights; and
performing a third operation on the input data and a plurality of sub-weights to generate a plurality of third computation results, and adjusting the threshold value of a current sub-weight based on the third computation result of a previous sub-weight.

9. The storage device according to claim 6, wherein the classification accelerator is configured for:
accumulating the comparison result to obtain an accumulation result;
comparing the accumulation result with a reference value to obtain an accumulation comparison result; and
updating the threshold value based on the accumulation comparison result and a threshold accumulation parameter.

10. The storage device according to claim 9, wherein the classification accelerator is configured for:
upon determining the first computation result of the computing in-memory unit is higher than the threshold value, incrementing the accumulation result by 1;
upon determining the accumulation comparison result is less than the reference value, not updating the threshold value; and
upon determining the accumulation comparison result is equal to or greater than the reference value, incrementing the threshold value with the threshold accumulation parameter to obtain the updated threshold value.
